(19) United States
(12) Patent Application Publication
(10) Pub. No.: US 2026/0261177 A1
(43) Pub. Date: Sep. 3, 2026

(54) Drive housing for an electric bicycle having a rib structure that forms a ventilation assembly and/or cooling air channels

(71) Applicant: Brose Antriebstechnik GmbH & Co. Kommanditgesellschaft, Berlin, Berlin (DE)

(72) Inventors: Christoph EHEHALT-BOHM, Kurnach (DE); Robert FRIEDLAND, Strausberg (DE); Stefanie PFRIEM, Gerbrunn (DE); Michael JACOB, Meura (DE); Daniel HUCKSTADT, Berlin (DE); Michael LUTZE, Wurzburg (DE); Stephan ROOS, Wertheim-Hohefeld (DE); Florian BAURLE, Berlin (DE)

(21) Appl. No.: 19/165,080

(22) PCT Filed: Mar. 12, 2024
(86) PCT No.: PCT/EP2024/056546

§ 371 Date: Sep. 12, 2025

(30) Foreign Application Priority Data
Mar. 14, 2023 (DE) 10 2023 106 365.0

(51) Int. Cl. H02K 5/20; B62M 6/55; H02K 5/173; H02K 5/18

(52) U.S. Cl. CPC H02K 5/207; B62M 6/55; H02K 5/173; H02K 5/18; H02K 2205/09

(57) ABSTRACT

The proposed solution relates in particular to a drive housing for a drive unit of an electric bicycle, having—a bearing section that is intended to mount at least part of a motor of the drive unit in an interior of the drive housing,—a housing opening via which the interior is connected to an exterior surrounding the drive housing, and—a ventilation assembly on the housing opening and configured to allow air to flow from the interior into the exterior and to prevent liquid from penetrating from the exterior into the interior. The ventilation assembly comprises a carrier component, mounted on the housing opening and having a plurality of interconnected air guidance channels, at least one of which opens into the interior, and which are covered towards the exterior by a cover element fixed on the carrier component.

### CROSS-REFERENCE TO RELATED APPLICATION

This application is a National Stage of International Application No. PCT/EP2024/056546 filed on Mar. 12, 2024, which claims priority from German Patent Application 10 2023 106 365.0, filed on Mar. 14, 2023. The contents of the above document are incorporated herein by reference in its entirety.

### BACKGROUND OF THE INVENTION

### Field of the Invention

The proposed solution relates in particular to a drive housing for a drive unit of an electric bicycle.

### Description of the Related Art

Drive units for electric bicycles with at least one motor drive are widely known. Typically, at least one electric motor of the drive unit is used to provide a drive torque generated by external force operation at an output element of the drive unit. The output element is coupled, for example, to a force transmission member such as a belt or a chain, which is connected to a rear wheel of the electric bicycle. The drive torque generated by external force operation is typically provided in addition to a drive torque generated by muscle force operation that is introduced at a pedal shaft via pedals.

Functionally relevant components of the drive unit, such as at least one motor of the drive unit, for example at least one electric motor, and electronic components necessary for controlling the drive, are accommodated in a drive housing. This drive housing can be assembled as a pre-assembled structural unit on a bicycle frame of the electric bicycle. In order to protect the components accommodated in an interior space of the drive housing from moisture, the drive housing is typically closed in a sealed manner. At the same time, however, it must be possible to ventilate the drive housing and/or dissipate heat from the interior space of the housing. For this purpose, it may be provided to form a housing opening on the drive housing, through which the interior space is connected to an exterior space surrounding the drive housing. In order not to let liquid enter the interior space of the drive housing unhindered through a corresponding housing opening, a ventilation assembly may be provided on the housing opening, which is configured to allow air to flow from the interior space to the exterior space and at the same time to prevent liquid from entering the interior space from the exterior space. However, drive housings for electric bicycles known to date still have room for improvement in this respect. A reliable ventilation of the drive unit via a housing opening on the drive housing is generally only possible under to a certain embodiment. In case of larger ventilation openings on the drive housing, on the other hand, there is a non-trivial risk of liquid entering the interior space of the drive housing, especially when an electric bicycle intended for sporty use cleaning with a high-pressure cleaner is performed. Furthermore, existing drive housings for electric bicycles are, at best, configured ergonomically and cooling-air-optimized to a limited extent. There is therefore non irrelevant potential for improvements in this regard.

### SUMMARY OF THE INVENTION

Against this background, the proposed solution provides a drive housing for a drive unit of an electric bicycle, which comprises a ventilation assembly at a housing opening of the drive housing, through which air from the interior space can flow into an exterior space surrounding the drive housing and which at the same time prevents liquid from the exterior space from entering the interior space. In a proposed drive housing, such a ventilation assembly comprises a carrier component assembled to the housing opening with several interconnected air guide ducts, at least one of which opens into the interior space and which are covered towards the exterior space by a cover element fixed to the carrier component.

By providing a carrier component with several interconnected air guide ducts for an air exchange between the interior space and the exterior space, the air guidance can be performed in a relatively well branched manner on the carrier component, which in turn makes it more difficult for liquid to enter into the interior space of the drive housing via these air ducts. In addition, by means of a cover element a protective coverage of the air guide ducts toward the exterior space is provided. The cover element fixed to the carrier component thus makes it more difficult for liquid to enter across the carrier component. In addition, by the provision of a separate component in the form of the cover element the design freedom can be increased. Thus, the cover element, which remains visible on the outside of the drive housing, can be designed in a relatively variable manner without having to modify the construction of the carrier component itself. Via the cover element, the ventilation assembly can be integrable into the drive housing in an aesthetically pleasing manner, for example for the placement of a logo and/or a brand name.

In one embodiment, the several air guide ducts of the carrier component are connected to each other in the manner of a labyrinth seal in order to connect at least one first flow opening of the carrier component, which opens in the interior space, to at least one second flow opening of the ventilation assembly, which is open to the exterior space. The at least two flow openings of the ventilation assembly can thus fluidically communicate via a labyrinth seal provided by the several air guide ducts. This enables gas and thus air exchange between the interior space and the exterior space. At the same time, however, the entrance of liquid into the interior space is effectively prevented.

In one embodiment, an air flow from the interior space can be guided from at least one first air guide duct of the carrier component into a second air guide duct (of the several air guide ducts of the carrier component) by deflecting the air flow, from which air can continue to flow toward the exterior space. For example, warm exhaust air generated during operation of the drive unit can flow from the at least one first air guide duct as part of an air flow into a second air guide duct on the carrier component. The deflection of the air flow occurring thereby helps to ensure that no liquid can enter the interior space in the opposite direction. For example, at least one passage is provided in a partition wall of the carrier component through which air from the first air guide duct can flow into the second air guide duct of the carrier component.

In one embodiment, the at least one first air guide duct of the several air guide ducts on the carrier component extends along an axis of extension pointing from the interior space to the exterior space. In a further development, for example, a deflection of the air flow from the first air guide duct in a radial direction, relative to the axis of extension of the first air guide duct, into the second air guide duct of the several (at least two) air guide ducts is provided via the at least one passage mentioned above. The passage thus enables an air flow to be directed inward or outward in the radial direction relative to the axis of extension, for example to conduct warm exhaust air from the interior space of the drive housing to the exterior space.

In one embodiment, at least one third air guide duct is part of the several air guide ducts of the carrier component. Air from the second air guide duct can flow into this third air guide duct through at least one connecting opening in a further partition wall of the carrier component. The third air guide duct can, for example, be provided radially further outward on the carrier component than the second air guide duct, relative to the axis of extension of the first air guide duct. It is provided, for example, that only air flowing sequentially through the first, second, and third air guide ducts reaches from the interior space to the exterior space at the ventilation assembly. Consequently, in order for air from the interior space of the drive housing to flow to the exterior space during operation of the drive unit, for example, the air must pass sequentially through the first, second, and third air guides ducts in this embodiment. Accordingly, liquid could only enter the interior space of the drive housing in the opposite direction. This is virtually impossible due to the interconnected and differently extended first, second, and third air guide ducts.

In one embodiment, the second air guide duct and/or the third air guide duct are formed annularly on the carrier component. For example, the second and/or third air guide ducts extend annularly around the axis of extension of the first air guide duct.

In order to further counteract the entrance of liquid into the interior space of the drive housing without preventing the air exchange between the interior space and the exterior space, an embodiment may provide that the air guide ducts are configured to deflect an air flow from the interior space at the carrier component multiple times (at least twice) before an outflow to the exterior space is possible. With reference to the embodiments described above, this includes, for example, that the first, second, and third air guide ducts are provided on the carrier component, to guide an air flow from the interior space initially along the axis of extension in the at least one first air guide duct and to guide it for inflow into the second and third air guide ducts at least once along a spatial direction that runs perpendicular to the axis of extension. In this case, the ventilation assembly may be further configured to allow air to flow out into the exterior space (for example, directly from the third air guide duct) along a spatial direction that also runs perpendicular to the axis of extension. For example, an air flow is guided for inflow into the second and third air guide ducts along a spatial direction which, relative to the axis of extension of the first air guide duct, points radially outward. In this case, the ventilation assembly may also be configured to allow air to flow out into the exterior space along a spatial direction which also points radially outward.

In one embodiment, at least one first air guide duct of the carrier component opens into the interior of the drive housing via at least one first flow opening, with at least one air-permeable membrane provided at this first flow opening. By the provision of an air-permeable membrane, the air exchange between the interior space and the exterior space is ensured, but it is more difficult for contaminants and/or liquid to enter into the interior space. In particular, in combination with one or more of the above-mentioned measures for the design of the air guide ducts on the carrier component, it is possible to virtually exclude that liquid and/or contaminants enter the interior space. The air guide ducts of the carrier component already prevent large quantities of dirt and/or liquid from the exterior space from reaching the membrane at the first flow opening. However, even the quantities of liquids or contaminants that reach the first flow opening can be prevented from entering the interior space via the at least one air-permeable membrane.

In one embodiment, at least one air duct is provided on an inner side of the cover element facing the carrier component, in particular formed, via which air flow guided along the carrier component in the direction of the exterior space can flow out into the exterior space. In such an embodiment, the cover element also defines a portion on the ventilation assembly for the targeted guidance of air toward the exterior space. Via the air guide ducts on the carrier component side, an air flow can be guided to the at least one air guide duct on the cover element and then thereby along the inner side of the cover element in a targeted manner outwards to the exterior space. The at least one air guide duct can thereby, for example, extend radially outward relative to an axis of extension of the at least one first air guide duct that opens into the interior space.

To facilitate assembly and/or simplify replacement of the cover element on the ventilation assembly, the cover element can, for example, be fixed to the carrier component via at least one plug connection. The plug connection between the cover element and the carrier component may be formed in such a way that the cover element can be plugged on and plugged off (removed) from the carrier component without the need for tools. For a corresponding detachable plug connection between the carrier component and the cover element, a plurality of plug pins may be provided, for example, on an inner side of the cover element facing the carrier component.

In principle, the housing opening closed by the ventilation assembly can be provided on the bearing portion of the drive housing where at least part of the motor of the drive unit is supported in the interior space of the drive housing.

For example, in this context, for a compact integration of the ventilation assembly, it can be provided that the housing opening is provided on the drive housing centered on a rotation axis about which a motor shaft of the drive is rotatable. The housing opening is then provided on a wall of the drive housing lying in the axial direction of the rotation axis. The ventilation assembly with its carrier component and its cover element is attached to this wall. For example, after the assembly of the motor into the drive housing, the ventilation assembly is attached from an outside to an outer side of the drive housing.

Another aspect of the proposed solution, which can be easily combined with the preceding first aspect and, in particular, with the embodiments explained above, provides for a drive housing that has at least one rib structure with several ribs on an outer side. A cooling air duct, which is configured to guide an incident flow of air resulting from the electric bicycle's movement along at least a part of the outer side of the drive housing and to deflect it at least once in a plane in which the cooling air ducts extends along the outer side, is formed between two adjacent ribs of the rib structure.

In relation to a state of the drive housing being installed on the electric bicycle, an outer side formed with a proposed rib structure can be located, for example, laterally, i.e., on a longitudinal side of the drive housing. This allows an incident flow to be guided laterally along the drive housing as targeted when the electric bicycle is moving. Via an appropriately configured rib structure an air flow can be guided to specific areas of the outer housing as target. Rib structures on drive housings for electric bicycles known from the practice so far provide, at best, rib structures that focus on at least local reinforcement of a drive housing or straight guidance of air on an outer side of the drive housing. In addition to an improved aesthetic appearance, in comparison thereto, the rib structure of the proposed solution allows for more targeted guidance of incident air, for example for cooling the drive unit during operation and/or improved aerodynamics in the area of the drive unit.

To deflect an air flow over the rib structure, a second portion of the cooling air duct can be defined by (respectively) two second guide portions of two adjacent ribs, which is continuous to a first portion of the cooling air duct defined by two first guide portions of the same two adjacent ribs, and which runs at an angle to the first portion of the cooling air duct. In one possible embodiment, the angle between the first and second portions of the cooling air duct is, for example, 30° or more, in particular in the range of 45° or more. However, the angle between the first and second portions of the cooling air duct typically does not exceed 90° and is, for example, below 80°.

At least one cooling air duct formed by the rib structure can be configured to guide air on an outer side of the drive housing toward a shaft portion of a pedal shaft of the drive unit. In addition, the rib structure allows to increase the rigidity of the housing and, in particular, to stiffen the bearing seat of the pedal shaft from the outside.

In principle, it may be provided that the cooling air ducts formed by the rib structure run parallel to each other, in particular over their entire extension on the outer side of the drive housing. In one embodiment, at least one cooling air duct of the rib structure is configured to guide air past a ventilation assembly in accordance with the first aspect explained above. Heat conducted to the outside on the ventilation assembly can be removed more effectively via (cooling) air guided past the ventilation assembly. In particular, the at least one cooling air duct of the rib structure can be configured to guide (cooling) air past at least one (second) flow opening of the ventilation assembly, through which air is allowed to flow out of the interior space of the drive housing into the surrounding exterior space.

The proposed solution also relates to an electric bicycle with a motor drive that comprises a drive housing according to one of the explained embodiments.

This includes, for example, an embodiment in which the drive housing is fixed to a bicycle frame of the electric bicycle and the drive housing is at least partially covered by a cover on the bicycle frame. In one embodiment, the cover on the bicycle frame has at least one inlet opening for air to flow in when the electric bicycle is moving. This air can be guided from the inlet opening towards a rib structure on the drive housing, which forms several cooling air ducts on the outer side of the drive housing. The at least one inlet opening on the cover of the bicycle frame is therefore configured to guide the air flow resulting from an incident flow when the electric bicycle is moving towards the rib structure of the drive housing, where this air flow—if necessary, divided among several cooling air ducts of the rib structure—is guided along the outer side of the drive housing and is deflected at least once in the process.

### BRIEF DESCRIPTION OF THE DRAWINGS

The accompanying figures illustrate exemplarily possible embodiments of the proposed solution.

FIGS. 1A-1B show a drive for an electric bicycle with an embodiment of a proposed drive housing, looking at two opposite longitudinal sides of the drive housing, each of which is formed with a rib structure;

FIG. 2 shows a sectional view through the drive housing of FIGS. 1A and 1B in the area of a ventilation assembly in excerpts;

FIG. 3 shows an enlarged excerpt of FIG. 2 looking at the ventilation assembly;

FIGS. 4A-4B show a carrier component of the fan assembly looking at an outside (FIG. 4A) and an inside (FIG. 4B);

FIGS. 5A-5B show a cover element of the ventilation assembly looking at an outside (FIG. 5A) and an inside (FIG. 5B);

FIG. 6 shows a frame of an electric bicycle with the drive of FIGS. 1A and 1B assembled thereto in excerpts.

### DETAILED DESCRIPTION OF THE DRAWINGS

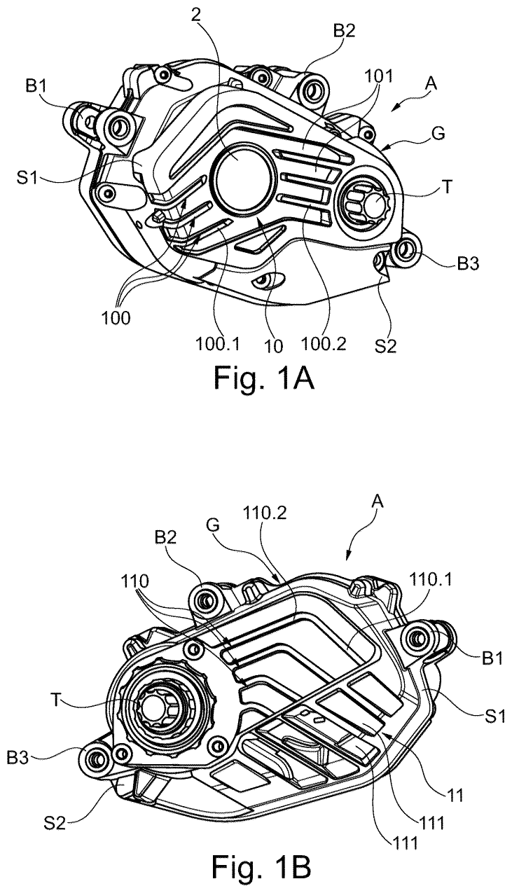

The FIGS. 1A and 1B show a drive A for an electric bicycle with a drive housing G looking at different longitudinal sides facing away from each other of the drive housing G. Drive A accommodates at least one electric motor for providing a motor drive force to move the electric bicycle. The motor drive force is provided as an assistance force to be combined with a drive force applied by the rider of the electric bicycle by muscle force operation. The drive force applied by muscle force operation can be applied via pedals arranged on shaft ends of a pedal shaft T each protruding at the longitudinal sides of the drive housing G. A drive element is supported coaxially with this pedal shaft T, via which a drive force can be transmitted to a force transmission member, such as a belt or a chain, in the state of being installed as intended to an electric bicycle of the drive A.

Several (in this case three) fastening locations B1, B2, and B3 are provided on an edge of the drive housing G connecting the two longitudinal sides, via which the drive A can be fixed to a frame of an electric bicycle.

The longitudinal sides of the drive housing G shown are each formed with a rib structure 10 or 11. The respective rib structure 10 or 11 has a plurality of adjacent ribs 100 or 110, each running parallel to one another. The ribs 100 or 110 of each longitudinal side run along the respective outer side of the drive housing G, whereby the ribs 100 or 110 do not run in a straight line. Instead, each rib 100 or 110 has two guide portions 100.1, 100.2 or 110.1, 110.2 continuous to each other and running at an angle to each other, in this case at an angle in the range of 45° to 70°. Thereby, a cooling air duct 101 or 111 between each pair of adjacent ribs 100 or 110 of the respective rib structure 10 or 11, which is configured to not only guide an incident flow of air at an end side of the drive housing G resulting from the movement of the electric bicycle along the respective longitudinal side of the drive housing G, but also to deflect the corresponding air flow at least once in each case, in the plane in which the respective cooling air duct 101 or 111 extends along the longitudinal side. An incident flow of air is thus not only guided along several cooling air ducts 101 or 111 on the respective outer side of the drive housing G as targeted via the ribs 110 or 110 folded or lying away on one longitudinal side of the outer housing G. Rather, the resulting incident flow is also deflected on the outer side of the drive housing G as targeted.

In this case, the deflection is performed such that an airflow occurring at an end side of the drive housing G is directed toward the protruding shaft ends of the pedal shaft T as targeted. In addition to the distinctive design of the drive housing G resulting from the folded rib structure 10 or 11, the shown rib structure 10 or 11 also incurs an effective cooling air flow on both outer sides of the drive housing G.

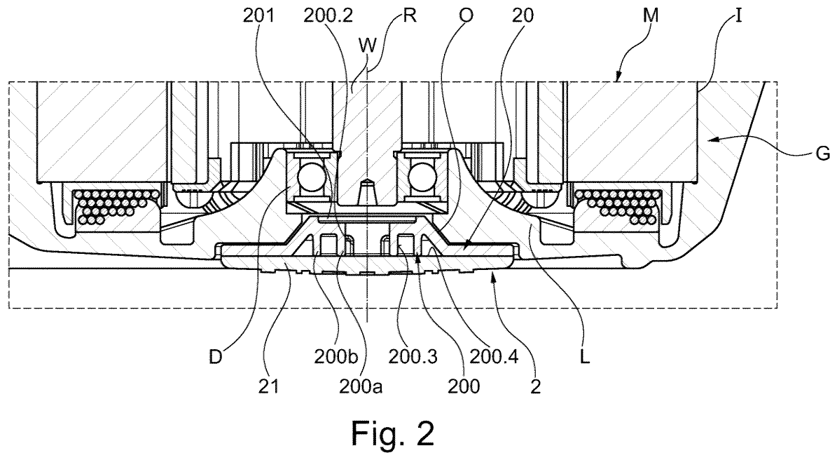

In the present case, cooling air is also guided past a ventilation assembly 2 of the drive A via the rib structure 10 of the one longitudinal side. Via this ventilation assembly 2, an exchange of air between an interior space I of the housing G and the surrounding exterior space is possible. This can, for example, assist in venting the drive housing G in the event of pressure fluctuations and also assist in dissipating heat from the interior of the drive housing G. The ventilation assembly 2 ensures that, despite the enabled air exchange, no undesired contamination or moisture reaches from the exterior space into the interior space I of the drive housing G. In addition, the ventilation assembly 2 is formed with a cover element 21 easily to assemble, which can be used as a logo carrier 21 (see FIGS. 2 to 5B in particular).

The ventilation assembly 2 is provided at a housing opening O of the drive housing G, corresponding to the sectional view of FIG. 2. In the present case, the housing opening O is located centered on a rotation axis R, about which a motor shaft W of an (electric) motor M of the drive A is rotatable in the interior space I of the drive housing G. In the present case, the housing opening O is provided on a bearing portion L of the drive housing G, on which part of the motor M is supported. In the embodiment shown, the bearing portion L carries, for example, a bearing, in particular a roller bearing, for the rotatable support of a shaft end of the motor shaft W. A part of a stator of the motor M may also be fixed to the bearing portion L.

The ventilation assembly 2 is here constructed from multiple parts and comprises, in particular, a carrier component in the form of a diaphragm carrier 20. This diaphragm carrier 20 is attached to the bearing portion L and is inserted at least partially into the housing opening O. A central portion 200 of the diaphragm carrier 20 engages in the housing opening O in a form-fitting manner. The central portion 200 is centered with respect to the rotation axis R of the motor shaft W.

In the radial direction, a sealing edge 202 of the diaphragm carrier 20 is continuous to the central portion 200. This sealing edge 202 extends completely circumferentially about the rotation axis R and, in the state of the ventilation assembly 2 being assembled as intended, abuts against a part of the bearing portion L in a sealing manner.

The diaphragm carrier 20 has a carrier portion 20A at the central portion 200, which protrudes conically in the direction of the interior space I and on which an air-permeable diaphragm 201 is held. Air, in particular warm exhaust air, can flow through this diaphragm 201 from the interior space I in the direction of the exterior space surrounding the drive housing G. Air flowing through the diaphragm 201 must pass through several air guide ducts 200.1, 200.3, and 200.4 on the membrane carrier 20, which are connected to each other in the manner of a labyrinth seal. These air guide ducts 200.1, 200.2, and 200.4 are provided on an outer side of the diaphragm carrier 20 facing the exterior space and are covered by the logo carrier 21. This logo carrier 21 is fixed to the outer side of the diaphragm carrier 20.

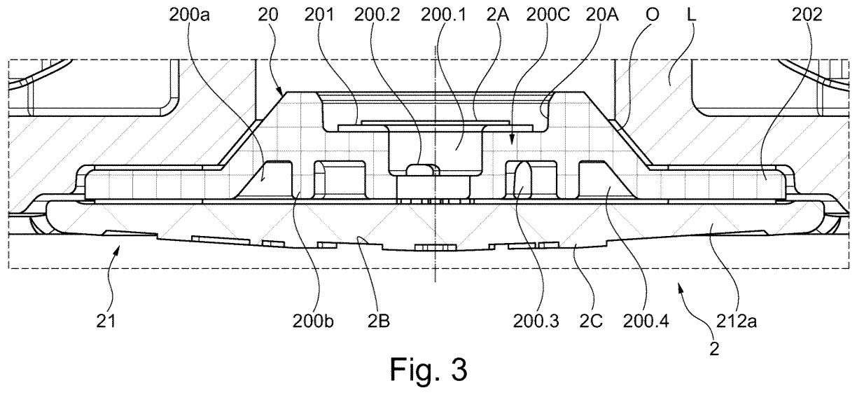

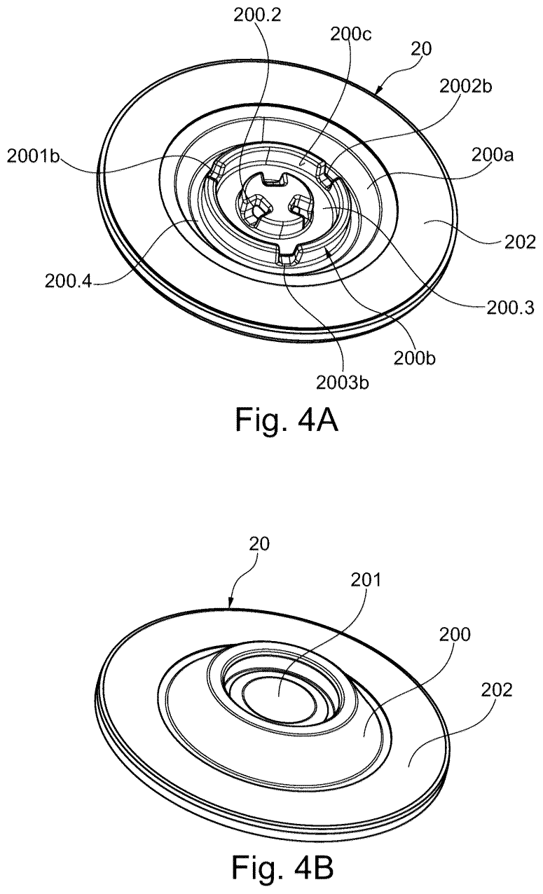

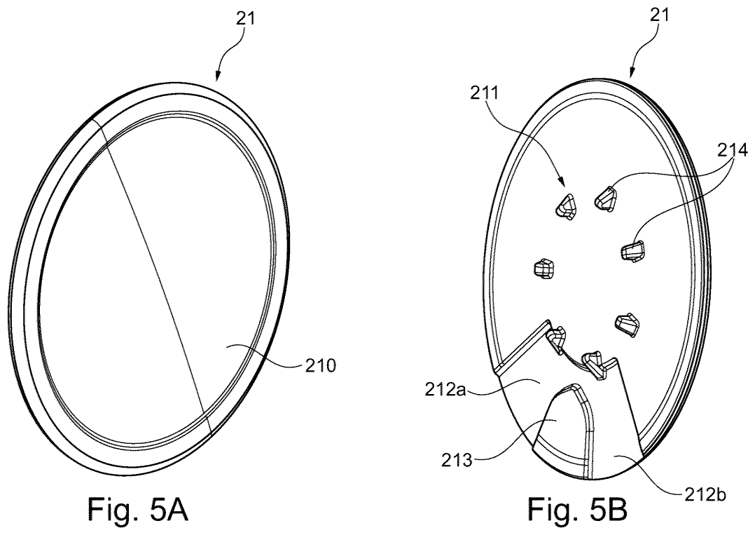

As can be seen in particular from the enlarged sectional view of the FIG. 3 and the individual views of the diaphragm carrier 20 in the FIGS. 4A and 4B and the individual views of the diaphragm carrier 21 in the FIGS. 5A and 5B, the diaphragm 201 closes a (first) flow opening 2A on the carrier portion 20A. A first air guide duct in the form of a central diaphragm duct 200.1 opens in the interior space I of the drive housing G via this flow opening 2A. The central diaphragm duct 200.1 is provided in extension of the rotation axis R of the motor shaft W and is formed on a central inner part 200c of the diaphragm carrier 20. Air can flow radially outwards from the central diaphragm duct 200.1 into a second air guide duct 200.3 via passages 200.2 in the walls of the central diaphragm duct 200.1. In the present case, this second air guide duct is offset axially with respect to the flow opening 2A and is formed in the form of an annular inner duct 200.3 on an outer side of the diaphragm carrier 20. In the present case, three passages 200.2 are provided, which are evenly distributed over a circumference of an end side wall of the central diaphragm duct 200.1 and through which air can flow from the central diaphragm duct 200.1 into the annular inner duct 200.3 (see in particular FIG. 4A).

The inner duct 200.3 is bordered in a radially outer direction (relative to the rotation axis R, which also forms an extension axis of the central diaphragm duct 200.1) by an outer ring partition wall 200b. This outer ring partition wall 200b, which is formed in a recess of the diaphragm carrier 20 and protrudes toward the exterior space, has several—in this case three and distributed evenly around the circumference-connecting openings 2001b, 2002b, and 2003b, through which air from the inner duct 200.3 can flow into an annular outer duct 200.4 located radially outward. This outer duct 200.4, as the third air guide duct of the diaphragm carrier 20, is bordered by the outer ring partition wall 200b on the radially inner side and by a funnel wall 200a on a radially outer side, which forms the inner wall of the recess on the diaphragm carrier 20.

Air can flow from the interior space I via the several interconnected air guide ducts 200.1, 200.3, and 200.4, as well as the passages 200.2 and connecting opening 2001b, which are not directly opposite each other but offset in the circumferential direction, 2002b and 203b, toward the exterior space surrounding the drive housing G only under multiple deflection by the diaphragm carrier 20. A ventilation of the drive housing G is therefore possible without further ado, but in the opposite direction, the entrance of liquid via the air guide ducts 200.1, 200.3, and 200.4 to the diaphragm 201 is virtually excluded.

To allow air to escape from the outer duct 200.4 at second flow openings 2B, 2C on the drive housing G, the logo carrier 21 has at least one, in this case two, air guide ducts 212a, 212b on an inner side 211 facing the diaphragm carrier 20. The air guide ducts 212a and 212b of the logo carrier 21 extend to an edge of the logo carrier 21 located on the radially outer side and are separated from each other by a central web 213 in the embodiment shown. The air guide ducts 212a and 212b are thus radially extended in the present case. They open into a common connecting portion which, in a state of the ventilation assembly 2 being assembled as intended, faces a portion of the outer duct 200.4 of the diaphragm carrier 20, so that air from the outer duct 200.4 reaches into the air guide ducts 212a and 212b on the inner side 211 of the logo carrier 21 thereby. The air is then guided radially outwards via the air guide ducts 212a, 212b to the flow openings 2B, 2C defined at the edge of the logo carrier 21 and can flow out into the outer space.

In order to fix the logo carrier 21 to the diaphragm carrier 20 without tools, the logo carrier 21 has several plug pins 214 on its inner side 211, which are spaced apart from each other along a circular line. Via these plug pins 214, the logo carrier 21 can be plugged onto the diaphragm carrier 20 during assembly of the drive A and, in particular, the ventilation assembly 2. Thereby, the logo carrier 21 is easily replaceable if necessary, in particular if a logo needs to be attached to its outer side 210 facing the outer side or if damage has occurred.

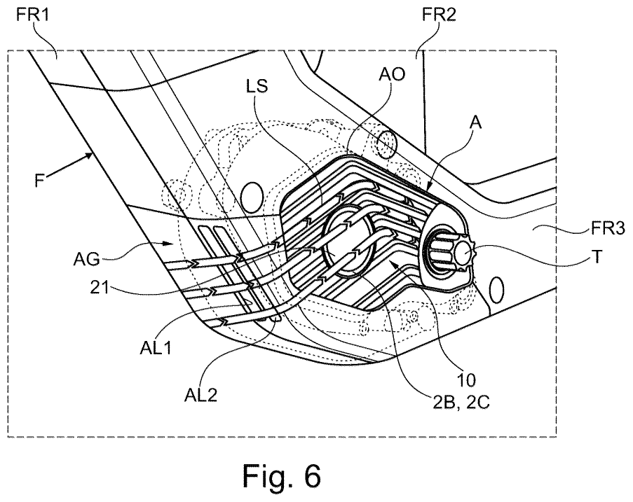

The FIG. 6 shows, in excerpts, a bicycle frame F of an electric bicycle equipped with the drive unit A of FIGS. 1A to 5B. The drive unit A is fixed at the intersection point of three frame parts FR1, FR2, and FR3 of the bicycle frame F. For example, the frame parts FR1, FR2, and FR3 are a down tube, a seat tube, and a chain stay of the bicycle frame F.

The drive unit A, which is thus positioned in a lower area of the bicycle frame F, is largely covered by a drive cover AG on the bicycle frame F in an aesthetically pleasing manner and being protected from environmental influences. The drive cover AG is formed, for example, by a plastic cap that is fixed to the frame part FR1 and thus, for example, to the down tube of the bicycle frame F. In the present case, only a cover opening AO is recessed respectively on the drive cover AG, through which the part of the respective longitudinal side of the drive housing G that forms the rib structure 10 or 11 is accessible and visible (whereby only one longitudinal side with the rib structure 10 is shown in FIG. 6).

Several inlet openings in the form of ventilation slots AL1 and AL2 are formed on one end side of the drive cover AG. When the electric bicycle is moving, air flowing onto the drive cover AG can flow behind the drive cover AG and to the drive unit A via these ventilation slots AL1 and AL2. Via the ventilation slots AL1 and AL2, an incident flow of air of the drive cover AG is guided to the rib structures 10 and 11 on the longitudinal sides of the drive housing G. Here, air flows LS resulting from the inflowing air are guided along the cooling air ducts 101 or 111 on the outer side of the drive housing G and are deflected at least once towards the protruding shaft ends of the pedal shaft T.

As can be seen from FIG. 6, at least one of the air flows LS is guided past the (second) flow openings 2B and 2C of the ventilation assembly 2. Via these flow openings 2B, 2C, air is allowed to escape from the interior space I of the drive housing G in a direction pointing radially outward and -in the installed state of the drive A-downward. This also allows moisture, in particular splash water, to penetrate at the flow openings 2B and 20 from below and thus, during intended use of the electric bicycle, against gravity. This also applies to cleaning the electric bicycle standing on its wheels. However, by the configuration of the ventilation assembly 2 described above entrance of liquid from to the flow opening 2A inside the drive housing G and, in particular, beyond the diaphragm 201 is virtually excluded.

In addition to the aerodynamically advantageous air guidance via the rib structure 10 with at least simple deflection of the resulting (cooling) air flows LS along the outer side of the drive housing G, the FIG. 6 also illustrates the function-oriented design of the contour of the drive housing G for its accommodation on the bicycle frame F. The parallel courses of the cooling air ducts 101 also reflect, in a certain way, the extension of the frame parts FR1, FR2, and FR3, in particular in the area of the outer side of the drive housing G formed with the rib structure 10, which remains accessible at the drive opening AO of the frame side drive cover G.

### LIST OF REFERENCE SIGNS

10 Rib structure
100 Rib
100.1, 100.2 Guide portion
101, 111 Cooling air duct
11 Rib structure
110 Rib
110.1, 110.2 Guide portion
2 Ventilation assembly
2A, 2B, 2C Flow opening
20 Diaphragm carrier (carrier component)
20A Carrier portion
200 Central portion
200.1 Central diaphragm duct (1st air guide duct)
200.2 Passage
200.3 Inner duct (2nd air guide duct)
200.4 Outer duct (3rd air guide duct)
2001b, 2002b, 2003b Connecting opening
200a Funnel wall
200b Outer ring partition wall
200c Inner part
201 Diaphragm
202 Sealing edge
21 Logo carrier (cover element)
210 Outer side
211 Inner side
212a, 212b Air guide duct
213 Central web
214 Plug pin
A Drive unit
AG Drive cover
AL1, AL2 Ventilation slot (inlet opening)
AO Cover opening
B1, B2, B3 Fastening location
D Roller bearing
F Bicycle frame
FR1, FR2, FR3 Frame part
G Drive housing
I Interior space
L Bearing portion
LS Air flow
M Motor
O Housing opening
R Rotation axis/extension axis
T Pedal shaft
W Motor shaft

What is claimed is:

1. A drive housing for a drive unit of an electric bicycle, comprising:
a bearing portion provided for supporting at least a part of a motor of the drive unit in an interior space of the drive housing,
a housing opening through which the interior space is connected to an exterior space surrounding the drive housing, and
a ventilation assembly at the housing opening, which is configured to allow air to flow from the interior space into the exterior space and to prevent liquid from entering from the exterior space to the interior space,
wherein
the ventilation assembly comprises a carrier component assembled to the housing opening with several of interconnected air guide ducts, at least one of which opens into the interior space and which are covered towards the exterior space by a cover element fixed to the carrier component.

2. The drive housing according to claim 1, wherein the several air guide ducts are connected to each other in the manner of a labyrinth seal in order to connect at least one first flow opening of the carrier component opening in the interior space to at least one second flow opening of the ventilation assembly open towards the exterior space.

3. The drive housing according to claim 1, wherein an air flow from the interior space is guidable from at least one first air guide duct of the carrier component into a second air guide duct by deflecting the air flow, from which air can continue to flow towards the exterior space.

4. The drive housing according to claim 3, wherein at least one passage is provided in a partition wall of the carrier component, through which air from the first air guide duct can flow into the second air guide duct.

5. The drive housing according to claim 1, wherein a first air guide duct of the several air guide ducts extends along an axis of extension pointing from the interior space towards the exterior space.

6. The drive housing according to the claim 4, wherein a deflection of an air flow from the first air guide duct in the radial direction, relative to the axis of extension, into the second air guide duct is provided via the at least one passage.

7. The drive housing according to claim 3, at least one third air guide duct is provided on the carrier component, into which air from the second air guide duct can flow through at least one connecting opening in a further partition wall, whereby it is provided that only air flowing successively through the first, second, and third air guide ducts reaches from the interior space to the exterior space at the ventilation assembly.

8. The drive housing according to claim 7, wherein the second and/or third air guide duct is formed annularly.

9. The drive housing according to claim 5, wherein the third air guide duct, relative to the axis of extension of the first air guide duct, is provided radially further out on the carrier component than the second air guide duct.

10. The drive housing according to claim 1, wherein the air guide ducts are configured to deflect an air flow from the interior space at the carrier component several times before an outflow into the exterior space is possible.

11. The drive housing according to claim 3, wherein the first, second, and third air guide ducts are provided on the carrier component to guide an air flow from the interior space initially along the axis of extension in the at least one first air guide duct and to guide it for inflow into the second and third air guide ducts along a first spatial direction, respectively, that runs perpendicular to the axis of extension, and the ventilation assembly is configured to allow the air to flow out into the exterior space along a spatial direction that also runs perpendicular to the axis of extension.

12. The drive housing according to claim 11, wherein the first, second, and third air guide ducts are provided on the carrier component to guide an air flow from the interior initially along the axis of extension in the at least one first air guide duct and to guide it along a first spatial direction which, relative to the axis of extension, points radially outwards, to flow into the second and third air guide ducts, and the ventilation assembly is configured to allow the air to flow out into the exterior space along a spatial direction which, relative to the axis of extension, also points radially outwards.

13. The drive housing according to claim 1, wherein at least one first air guide duct of the carrier component opens in the interior space via at least one first flow opening and at least one air-permeable membrane is provided at the first flow opening.

14. The drive housing according to claim 1, wherein at least one air guide duct is provided on an inner side of the cover element facing the carrier component, through which an air flow guided on the carrier component towards the exterior space can flow into the exterior space.

15. The drive housing according to claim 1, wherein the at least one air guide duct, radially outward, relative to the axis of extension of the at least one first air guide duct opening into the interior space.

16. The drive housing according to claim 1, wherein the cover element is fixed to the carrier component via at least one plug connection.

17. The drive housing according claim 1, wherein housing opening is provided on the bearing portion.

18. The drive housing according to claim 1, wherein housing opening is provided on the drive housing centered on a rotation axis about which a motor shaft of the drive is rotatable.

19. The drive housing for a drive unit of an electric bicycle, according to claim 1 further comprising, an outer side on which at least one rib structure with several ribs is provided,
wherein
a cooling air duct is formed between two adjacent ribs of the rib structure, which is configured to guide incident flow of air resulting from the electric bicycle being moved along at least a part of the outer side of the drive housing and to deflect it at least once in a plane in which the cooling air duct extends along the outer side.

20-24. (canceled)

25. An electric bicycle with a motor drive comprising a drive housing comprising a bearing portion provided for supporting at least a part of a motor of the drive unit in an interior space of the drive housing.
a housing opening through which the interior space is connected to an exterior space surrounding the drive housing, and
a ventilation assembly at the housing opening, which is configured to allow are to follow from the interior space into the exterior space and to prevent liquid from entering from the exterior space to the interior space,
wherein
the ventilation assembly comprises a carrier component assembled in the housing opening with several of interconnected are guide ducts, at least one of which opens into the interior space and which are covered towards the exterior space by a cover element fixed to the carrier component.

26. (canceled)
